(19) United States
(12) Patent Application Publication
(10) Pub. No.: US 2024/0194904 A1
(43) Pub. Date: Jun. 13, 2024

(54) SYSTEMS AND METHODS FOR OPERATING A FUEL CELL COMPRESSOR AS A COOLANT HEATER

(71) Applicant: HYDROGENICS CORPORATION, Mississauga (CA)

(72) Inventors: Justin Roberto RIZZI, Oshawa (CA); Paolo FORTE, Maple (CA); Salvatore RANIERI, Etobicoke (CA); Sumit TRIPATHI, Columbus, IN (US); Prabhsimran MALHI, Brampton (CA)

(21) Appl. No.: 18/526,962

(22) Filed: Dec. 1, 2023

Related U.S. Application Data
(60) Provisional application No. 63/387,193, filed on Dec. 13, 2022.

(51) Int. Cl. H01M 8/04014; H01M 8/04223; H01M 8/0432; H01M 8/04746

(52) U.S. Cl. CPC H01M 8/04014; H01M 8/04253; H01M 8/04358; H01M 8/04776

(57) ABSTRACT

The present disclosure generally relates to systems and methods for operating a fuel cell system, including a coolant stream flowing through a fuel cell stack, a compressor configured to flow in a first air stream comprising a first air temperature and flow out a second air stream comprising a second air temperature, a charge cooler comprising the coolant stream configured to flow in the second air stream comprising the second air temperature, further configured to decrease the second air temperature, and flow out a third air stream comprising a third air temperature, along with a controller configured to regulate operation of the fuel cell system, including the fuel cell stack, the compressor, and the charge cooler.

### CROSS-REFERENCE TO RELATED APPLICATIONS

This nonprovisional application claims the benefit and priority, under 35 U.S.C. § 119(e) and any other applicable laws or statues, to U.S. Provisional Patent Application Ser. No. 63/387,193 filed on Dec. 13, 2022, the entire disclosure of which is hereby expressly incorporated herein by reference.

### TECHNICAL FIELD

The present disclosure relates to systems and methods of configuring, designing, and/or utilizing a compressor and a charge cooler to heat a coolant stream in a fuel cell stack.

### BACKGROUND

A fuel cell system or fuel cell stack typically cannot start in cold temperature conditions without warming up. The fuel cell system or stack includes a coolant stream that functions as a heat sink for any heat that may be rejected during its electrochemical reactions. The coolant stream is configured to keep the fuel cell stack from overheating during operation.

The fuel cell system may require a heating assist system that is configured to warm up and raise the temperature of the fuel cell system. Typically, the coolant is circulated in the fuel cell stack to increase the temperature of the fuel cell stack under low temperature conditions (e.g., around or below freezing temperatures). A coolant heater (e.g., electrical heater) may be utilized to heat the coolant during circulation.

An electrical heater that uses a battery or an external power source may be utilized to increase the temperature of the fuel cell system. Such electrical or coolant heaters are used to increase the coolant temperature to about −5° C. However, such electrical heaters can be large, difficult to package, and/or expensive. Additionally, the high current requirement of electrical heaters requires substantial wiring and increases system cost. Thus, there is a need for optimizing the heating of the fuel cell systems under certain operating conditions (e.g., at freezing ambient temperature).

The present disclosure provides systems and methods for controlling, regulating, and/or utilizing heat energy from a compressor outlet stream to heat the circulating coolant stream in the fuel cell system under cold temperature conditions. The present disclosure provides systems and methods that utilize and/or operate one or more valves to utilize the heat energy to heat the coolant and/or to heat the fuel cell stack.

### SUMMARY

Embodiments of the present disclosure are included to meet these and other needs.

In one aspect, described herein, a fuel cell system, comprising a coolant stream flowing through a fuel cell stack, a compressor including a compressor inlet and a compressor outlet, configured to flow a first air stream comprising a first air temperature into the compressor inlet and a second air stream comprising a second air temperature out of the compressor outlet. A charge cooler including a charge cooler inlet and a charge cooler outlet are configured to flow the second air stream comprising the second air temperature into the charge cooler inlet and a third air stream comprising a third air temperature out of the charge cooler outlet. The second air temperature is higher than the first air temperature and the third air temperature is lower than the second air temperature. A controller is configured to regulate operation of the fuel cell stack, the compressor, and the charge cooler.

In some embodiments, the heat energy from the second air stream is configured to increase a first coolant temperature of the coolant stream to a second coolant temperature when the coolant stream flows through the charge cooler.

In some embodiments, the coolant stream comprising the second coolant temperature is configured to flow through the fuel cell stack after flowing through the charge cooler and the fuel cell stack is heated by the coolant stream comprising the second temperature.

In some embodiments, the system may further comprise a by-pass valve configured to flow a first portion of the third air stream into an exhaust. In some embodiments, the coolant stream comprising the second coolant temperature is configured to flow through the fuel cell stack after flowing through the charge cooler and the fuel cell stack is heated by the coolant stream comprising the second temperature.

In some embodiments, the system may further comprise the third air stream flowing through the fuel cell stack and a backpressure valve configured to flow the third air stream into an exhaust after the third air stream exits the fuel cell stack. In some embodiments, the coolant stream comprising the second coolant temperature is configured to flow through the fuel cell stack and heat the fuel cell stack. In some embodiments, the third air stream flowing through the fuel cell stack is configured to melt frozen water in a cathode channel in the fuel cell stack.

In some embodiments, the system may further comprise a backpressure valve and a by-pass valve, wherein the controller is configured to operate the backpressure valve or the by-pass valve based on coolant temperature, ambient temperature, or an operating state of the fuel cell stack. In some embodiments, the second air temperature depends on a ratio of a pressure of the first air stream to a pressure of the second air stream. In some embodiments, the second air temperature ranges from about 40° C. to about 230° C. In some embodiments, the third air temperature ranges from about 40° C. to about 100° C. In some embodiments, the second coolant temperature ranges from about 40° C. to about 100° C.

In another aspect, described herein, a method of operating a fuel cell system comprises implementing a control system to operate the fuel cell system, flowing a first air stream through a compressor at a first air temperature, flowing a second air stream out of the compressor and into a charge cooler at a second air temperature higher than the first air temperature, flowing a third air stream out of the charge cooler at a third air temperature lower than the second air temperature, and. flowing a coolant stream through the charger cooler and a fuel cell stack, wherein heat energy from the second air stream is configured to increase a first coolant temperature of the coolant stream to a second coolant temperature.

In some embodiments, the method may further comprise flowing a first portion of the third air stream into an exhaust via a by-pass valve. In some embodiments, the method may further comprise flowing a first portion of the third air stream into the fuel cell stack before flowing the second portion of the third air stream into an exhaust, wherein flowing the second portion of the third air stream into the exhaust comprises the control system operating a backpressure valve. In some embodiments, the method may further comprise flowing the coolant stream comprising the second coolant temperature through the fuel cell stack and heating the fuel cell stack.

In some embodiments, the method may further comprise the controller: a) operating a by-pass valve for flowing a first portion of the third air stream to an exhaust or b) flowing a second portion of the third air stream through the fuel cell stack and to a backpressure valve before the exhaust. In some embodiments, the method may further comprise the control system operating the backpressure valve or the by-pass valve based on a coolant temperature, an ambient temperature, or an operating state of the fuel cell stack. In some embodiments, the method may further comprise the controller opening the by-pass valve and closing the backpressure valve for a first duration and closing the by-pass valve and opening the backpressure valve for a second duration.

### BRIEF DESCRIPTION OF THE DRAWINGS

FIG. 1A is a schematic view of an exemplary fuel cell system including an air delivery system, a hydrogen delivery system, and a fuel cell module including a stack of multiple fuel cells;

FIG. 1B is a cutaway view of an exemplary fuel cell system including an air delivery system, hydrogen delivery systems, and a plurality of fuel cell modules each including multiple fuel cell stacks;

FIG. 1C is a perspective view of an exemplary repeating unit of a fuel cell stack of the fuel cell system of FIG. 1A;

FIG. 1D is a cross-sectional view of an exemplary repeating unit of the fuel cell stack of FIG. 1C;

FIG. 2 is an illustration of one embodiment of a fuel cell system including a compressor and a cool charger;

FIG. 3 is an illustration of the fuel cell system of FIG. 2 operating with an open by-pass valve and a close backpressure valve;

FIG. 4 is an illustration of the fuel cell system of FIG. 2 operating with a closed by-pass valve and an open backpressure valve; and

FIG. 5 is an illustration of one embodiment of a control system used in FIGS. 3 and 4.

### DETAILED DESCRIPTION

The present disclosure provides systems and methods for controlling, regulating, and/or utilizing heat energy from a compressor outlet stream in a fuel cell system to heat a circulating coolant stream or to heat one or more components of a fuel cell stack.

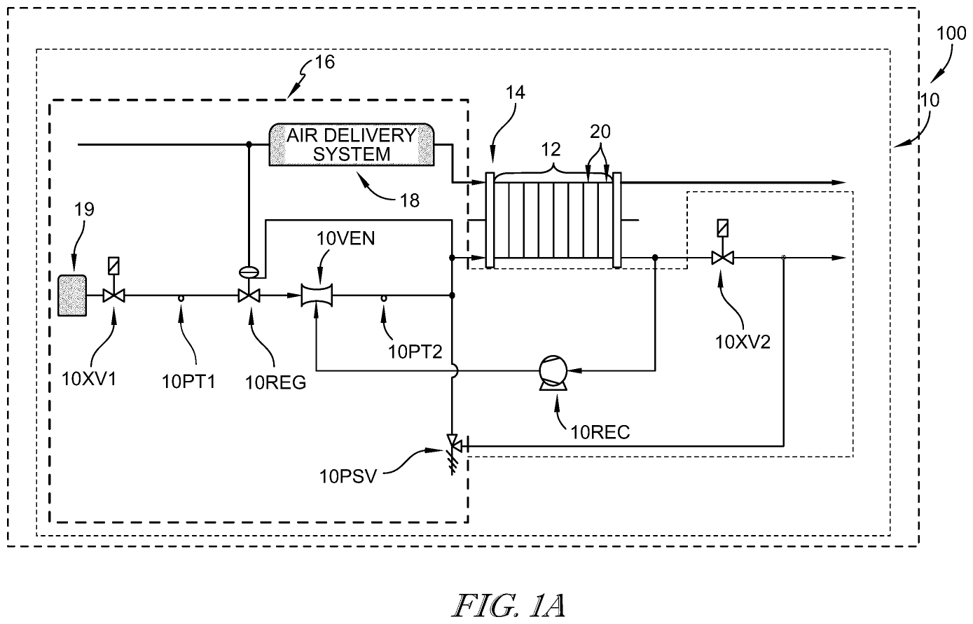

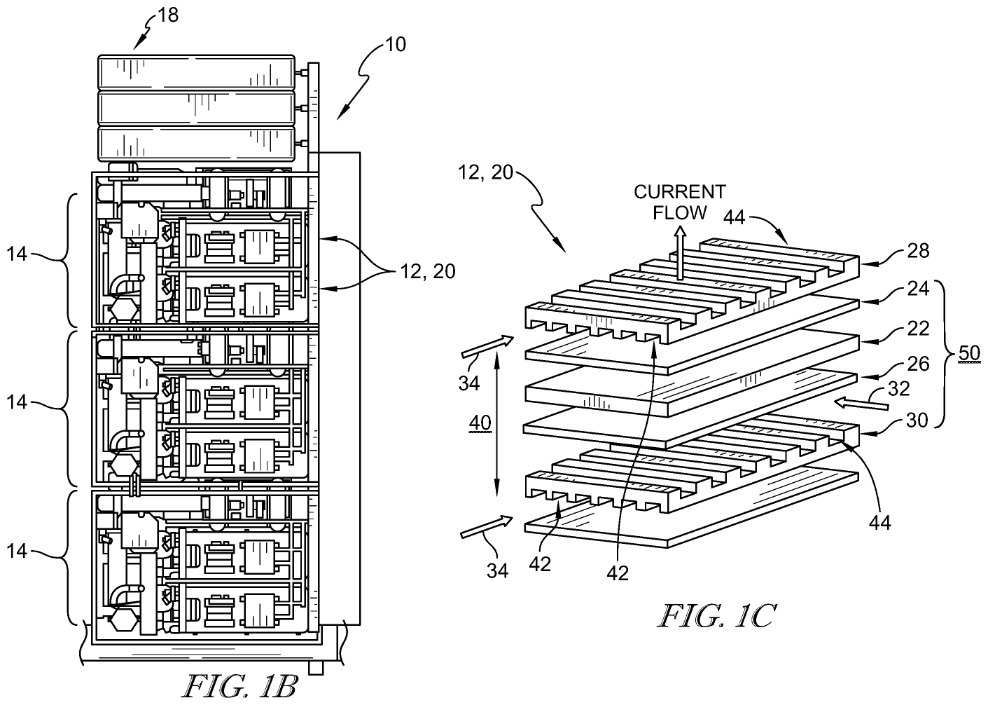

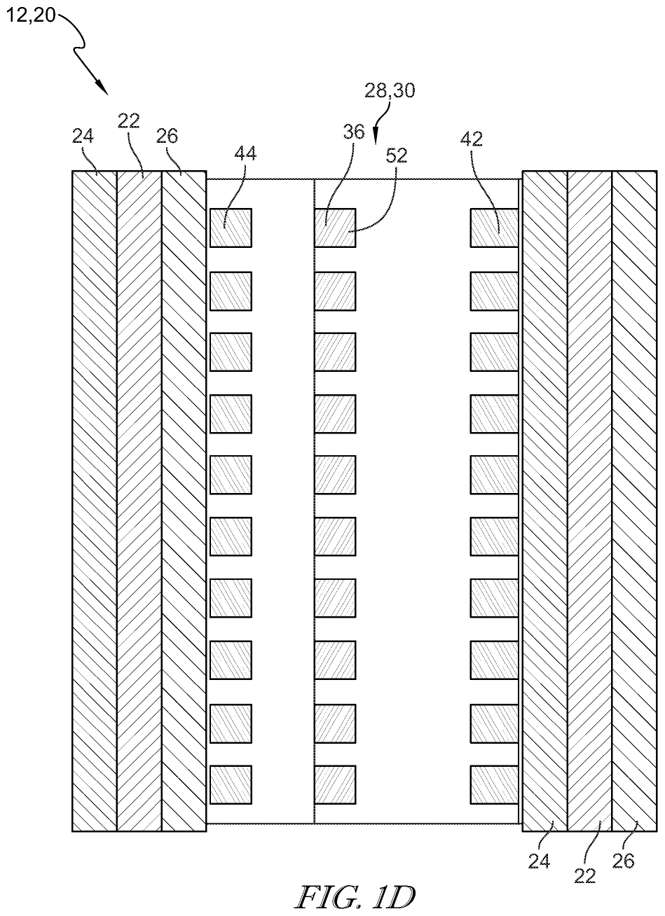

As shown in FIG. 1A, fuel cell systems 10 often include one or more fuel cell stacks 12 (“STK”) or fuel cell modules 14 connected to a balance of plant (BOP) 16, including various components, to support the electrochemical conversion, generation, and/or distribution of electrical power to help meet modern day industrial and commercial needs in an environmentally friendly way. As shown in FIGS. 1B and 1C, fuel cell systems 10 may include fuel cell stacks 12 comprising a plurality of individual fuel cells 20. Each fuel cell stack 12 may house a plurality of fuel cells 20 assembled together in series and/or in parallel. The fuel cell system 10 may include one or more fuel cell modules 14 as shown in FIGS. 1A and 1B.

Each fuel cell module 14 may include a plurality of fuel cell stacks 12 and/or a plurality of fuel cells 20. The fuel cell module 14 may also include a suitable combination of associated structural elements, mechanical systems, hardware, firmware, and/or software that is employed to support the function and operation of the fuel cell module 14. Such items include, without limitation, piping, sensors, regulators, current collectors, seals, and insulators.

The fuel cells 20 in the fuel cell stacks 12 may be stacked together to multiply and increase the voltage output of a single fuel cell stack 12. The number of fuel cell stacks 12 in a fuel cell system 10 can vary depending on the amount of power required to operate the fuel cell system 10 and meet the power need of any load. The number of fuel cells 20 in a fuel cell stack 12 can vary depending on the amount of power required to operate the fuel cell system 10 including the fuel cell stacks 12.

The number of fuel cells 20 in each fuel cell stack 12 or fuel cell system 10 can be any number. For example, the number of fuel cells 20 in each fuel cell stack 12 may range from about 100 fuel cells to about 1000 fuel cells, including any specific number or range of number of fuel cells 20 comprised therein (e.g., about 200 to about 800). In an embodiment, the fuel cell system 10 may include about 20 to about 1000 fuel cells stacks 12, including any specific number or range of number of fuel cell stacks 12 comprised therein (e.g., about 200 to about 800). The fuel cells 20 in the fuel cell stacks 12 within the fuel cell module 14 may be oriented in any direction to optimize the operational efficiency and functionality of the fuel cell system 10.

The fuel cells 20 in the fuel cell stacks 12 may be any type of fuel cell 20. The fuel cell 20 may be a polymer electrolyte membrane or proton exchange membrane (PEM) fuel cell, an anion exchange membrane fuel cell (AEMFC), an alkaline fuel cell (AFC), a molten carbonate fuel cell (MCFC), a direct methanol fuel cell (DMFC), a regenerative fuel cell (RFC), a phosphoric acid fuel cell (PAFC), or a solid oxide fuel cell (SOFC). In an exemplary embodiment, the fuel cells 20 may be a polymer electrolyte membrane or proton exchange membrane (PEM) fuel cell or a solid oxide fuel cell (SOFC).

In an embodiment shown in FIG. 1C, the fuel cell stack 12 includes a plurality of proton exchange membrane (PEM) fuel cells 20. Each fuel cell 20 includes a single membrane electrode assembly (MEA) 22 and a gas diffusion layers (GDL) 24, 26 on either or both sides of the membrane electrode assembly (MEA) 22 (see FIG. 1C). The fuel cell 20 further includes a bipolar plate (BPP) 28, 30 on the external side of each gas diffusion layers (GDL) 24, 26, as shown in FIG. 1C. The above-mentioned components, in particular the bipolar plate 30, the gas diffusion layer (GDL) 26, the membrane electrode assembly (MEA) 22, and the gas diffusion layer (GDL) 24 comprise a single repeating unit 50.

The bipolar plates (BPP) 28, 30 are responsible for the transport of reactants, such as fuel 32 (e.g., hydrogen) or oxidant 34 (e.g., oxygen, air), and cooling fluid 36 (e.g., coolant and/or water) in a fuel cell 20. The bipolar plates (BPP) 28, 30 can uniformly distribute reactants 32, 34 to an active area 40 of each fuel cell 20 through oxidant flow fields 42 and/or fuel flow fields 44 formed on outer surfaces of the bipolar plates (BPP) 28, 30. The active area 40, where the electrochemical reactions occur to generate electrical power produced by the fuel cell 20, is centered, when viewing the stack 12 from a top-down perspective, within the membrane electrode assembly (MEA) 22, the gas diffusion layers (GDL) 24, 26, and the bipolar plate (BPP) 28, 30.

The bipolar plates (BPP) 28, 30 may each be formed to have reactant flow fields 42, 44 formed on opposing outer surfaces of the bipolar plate (BPP) 28, 30, and formed to have coolant flow fields 52 located within the bipolar plate (BPP) 28, 30, as shown in FIG. 1D. For example, the bipolar plate (BPP) 28, 30 can include fuel flow fields 44 for transfer of fuel 32 on one side of the plate 28, 30 for interaction with the gas diffusion layer (GDL) 26, and oxidant flow fields 42 for transfer of oxidant 34 on the second, opposite side of the plate 28, 30 for interaction with the gas diffusion layer (GDL) 24. As shown in FIG. 1D, the bipolar plates (BPP) 28, 30 can further include coolant flow fields 52 formed within the plate (BPP) 28, 30, generally centrally between the opposing outer surfaces of the plate (BPP) 28, 30. The coolant flow fields 52 facilitate the flow of cooling fluid 36 through the bipolar plate (BPP) 28, 30 in order to regulate the temperature of the plate (BPP) 28, 30 materials and the reactants. The bipolar plates (BPP) 28, 30 are compressed against adjacent gas diffusion layers (GDL) 24, 26 to isolate and/or seal one or more reactants 32, 34 within their respective pathways 44, 42 to maintain electrical conductivity, which is required for robust operation of the fuel cell 20 (see FIGS. 1C and 1D).

The fuel cell system 10 described herein, may be used in stationary and/or immovable power system, such as industrial applications and power generation plants. The fuel cell system 10 may also be implemented in conjunction with an air delivery system 18. Additionally, the fuel cell system 10 may also be implemented in conjunction with a hydrogen delivery system and/or a source of hydrogen 19 such as a pressurized tank, including a gaseous pressurized tank, cryogenic liquid storage tank, chemical storage, physical storage, stationary storage, an electrolysis system, or an electrolyzer. In one embodiment, the fuel cell system 10 is connected and/or attached in series or parallel to a hydrogen delivery system and/or a source of hydrogen 19, such as one or more hydrogen delivery systems and/or sources of hydrogen 19 in the BOP 16 (see FIG. 1A). In another embodiment, the fuel cell system 10 is not connected and/or attached in series or parallel to a hydrogen delivery system and/or a source of hydrogen 19.

In some embodiments, the fuel cell system 10 may include an on/off valve 10XV1, a pressure transducer 10PT1, a mechanical regulator 10REG, and a venturi 10VEN arranged in operable communication with each other and downstream of the hydrogen delivery system and/or source of hydrogen 19. The pressure transducer 10PT1 may be arranged between the on/off valve 10XV1 and the mechanical regulator 10REG. In some embodiments, a proportional control valve may be utilized instead of a mechanical regulator 10REG. In some embodiments, a second pressure transducer 10PT2 is arranged downstream of the venturi 10VEN, which is downstream of the mechanical regulator 10REG.

In some embodiments, the fuel cell system 10 may further include a recirculation pump 10REC downstream of the stack 12 and operably connected to the venturi 10VEN. The fuel cell system 10 may also include a further on/off valve 10XV2 downstream of the stack 12, and a pressure transfer valve 10PSV.

The present fuel cell system 10 may also be comprised in mobile applications. In an exemplary embodiment, the fuel cell system 10 is in a vehicle and/or a powertrain 100. A vehicle 100 comprising the present fuel cell system 10 may be an automobile, a pass car, a bus, a truck, a train, a locomotive, an aircraft, a light duty vehicle, a medium duty vehicle, or a heavy-duty vehicle. Type of vehicles 100 can also include, but are not limited to commercial vehicles and engines, trains, trolleys, trams, planes, buses, ships, boats, and other known vehicles, as well as other machinery and/or manufacturing devices, equipment, installations, among others.

The vehicle and/or a powertrain 100 may be used on roadways, highways, railways, airways, and/or waterways. The vehicle 100 may be used in applications including but not limited to off highway transit, bobtails, and/or mining equipment. For example, an exemplary embodiment of mining equipment vehicle 100 is a mining truck or a mine haul truck.

In addition, it may be appreciated by a person of ordinary skill in the art that the fuel cell system 10, fuel cell stack 12, and/or fuel cell 20 described in the present disclosure may be substituted for any electrochemical system, such as an electrolysis system (e.g., an electrolyzer), an electrolyzer stack, and/or an electrolyzer cell (EC), respectively. As such, in some embodiments, the features and aspects described and taught in the present disclosure regarding the fuel cell system 10, stack 12, or cell 20 also relate to an electrolyzer, an electrolyzer stack, and/or an electrolyzer cell (EC). In further embodiments, the features and aspects described or taught in the present disclosure do not relate, and are therefore distinguishable from, those of an electrolyzer, an electrolyzer stack, and/or an electrolyzer cell (EC).

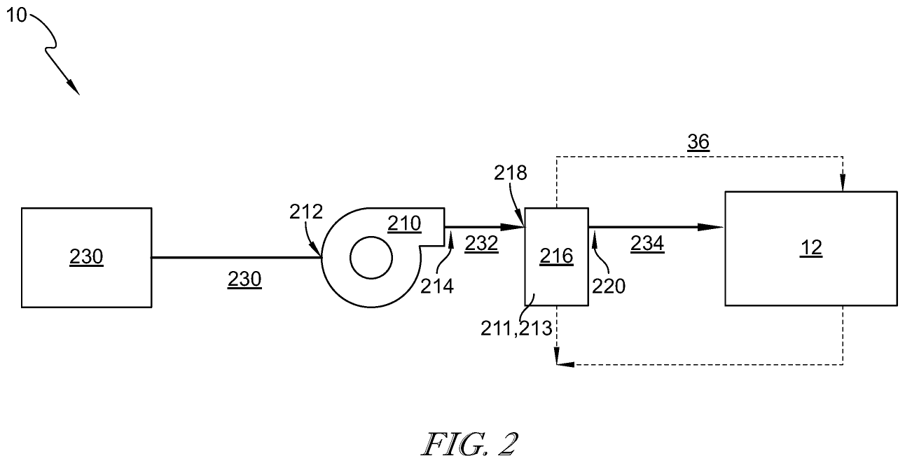

Risk of in-stack freezing must be eliminated and/or minimized for the fuel cell stack 12 to be operational under cold operating conditions (e.g., for cold start-up). Heat of the coolant 36 may be utilized to render the fuel cell system 10 operational at cold operating conditions. Heat from a compressor 210 (FIG. 2) in the fuel cell system 10 can be used to raise the temperature of the coolant 36 to be within a minimum operating temperature range. The minimum operating temperature range of the coolant 36 may depend on the fuel cell stack 12 technology (e.g., operating voltage, current etc.). For example, the minimum operating temperature range of the coolant 36 may range from about −5° C. to about 5° C., including any specific or range of temperature comprised therein.

Consequently, when the fuel cell stack 12 is operational after reaching the minimum operating temperature, the fuel cell stack 12 may provide further heat to the coolant 36 increasing the temperature of the coolant 36 to an optimal operating temperature. The optimal operating temperature of the coolant 36 may range from about 60° C. to about 100° C., including any specific or range of temperature comprised therein. For example, the optimal operating temperature of the coolant 36 may range from about 60° C. to about 70° C., from about 70° C. to about 80° C., from about 80° C. to about 90° C., or from about 90° C. to about 100° C. The ability to provide heat to the fuel cell system 10 from the circulating coolant 36 without utilizing heaters or burners may advantageously decrease the complexity and/or size of the fuel cell system 10.

FIG. 2 illustrates one embodiment of the fuel cell system 10 comprising a compressor 210 and a charge cooler 216. In some embodiments, the fuel cell system 10 may comprise one or more fuel cell stacks 12 and/or one or more fuel cells 20. In other embodiments, there may also be one or multiple valves, sensors, compressors, regulators, blowers, injectors, ejectors, and/or other devices in series or in parallel with the fuel cell stack 12. The compressor 210 may be utilized, designed, configured, and/or operated to change the pressure and/or temperature of an air stream (e.g., filtered air stream 230) flowing through the compressor 210. The charge cooler 216 may be utilized, designed, configured, and/or operated to change the pressure and/or temperature of an air stream (e.g., a compressor outlet stream 232) flowing through the charge cooler 216.

Different components of the fuel cell system 10 can be utilized to supply an air (e.g., a charge cooler outlet stream 234) to the fuel cell stack 12. However, a pressure increase in the filtered air stream 230 as it flows through the compressor 210 can result in an increase in the ambient temperature of the filtered air stream 230 due to compression when it exits the compressor 210 as the compressor outlet stream 232. Thus, the temperature of the compressor outlet stream 232 can be greater than the ambient temperature, where the ambient temperature is the surrounding environmental temperature at the location where the fuel cell system 10 is operating

The temperature of the compressor outlet stream 232 can be substantially more or greater than the temperature of the filtered air stream 230. The temperature of the compressor outlet stream 232 can range from about 40° C. to about 230° C., including any temperature or range of temperature comprised therein. Specifically, the temperature of the compressor outlet stream 232 may range from about 40° C. to about 60° C., from about 60° C. to about 80° C., about 80° C. to about 100° C., about 100° C. to about 140° C., about 140° C. to about 180° C., from about 180° C. to about 200° C., or from about 100° C. to about 230° C.

The temperature of the compressor outlet stream 232 may depend on an operating pressure and an operating altitude of the fuel cell system 10. The temperature of the compressor outlet stream 232 can also depend on and/or be determined or be established by a ratio of a pressure at the compressor inlet 212 and a pressure at the compressor outlet 214.

The change in temperature of the compressor outlet stream 232 compared to the temperature of the filtered air stream 230 and a mass flow rate of the filtered air stream 230 through the compressor 210 can be used to calculate a heat energy in the compressor outlet stream 232. For example, in some fuel cell systems 10, the amount of the heat energy in the compressor outlet stream 232 may range from about 16 kW to about 25 KW, including any amount or range of energy comprised therein. However, the compressor outlet stream 232 may need to be cooled to match the operating temperature of the fuel cell stack 12 before the compressor outlet stream 232 is passed through the fuel cell stack 12.

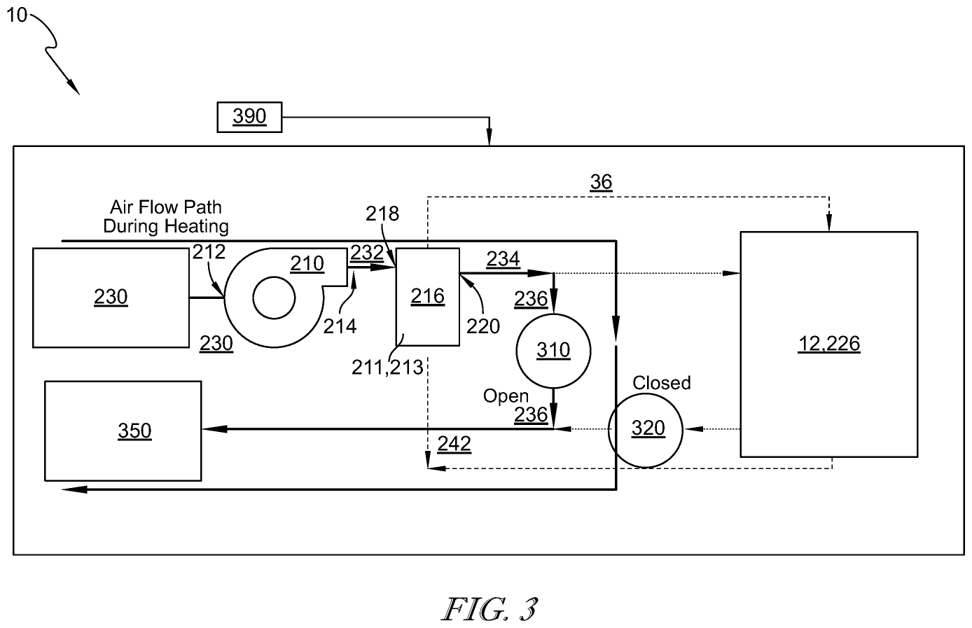

In some embodiments, as shown in FIG. 3, components of the charge cooler 216 including a motor 211 and/or power electronics 213 can be cooled by the coolant 36 circulating through the fuel cell stack 12. For example, coolant 36 flowing from the fuel cell stack 12 through the charge cooler 216 can be utilized and/or implemented to lower the temperature of the compressor outlet stream 232 as it flows through the charge cooler 216. The charge cooler 216 can be integrated with the system 10 and/or operated as a liquid-to-air heat exchanger on the same coolant 36 pathway as the fuel cell stack 12.

Heat energy from the compressor outlet stream 232 can be transferred to heat the coolant 36 flowing through the charge cooler 216. A temperature of the charge cooler outlet stream 234 may depend on or be the same as the operating temperature of the fuel cell system 10, which can range from about −40° C. to about 100° C., including any temperature or range of temperatures comprised therein. For example, the temperature of the charge cooler 216 and/or the charge cooler outlet stream 234 can range from about −40° C. to about −10° C., about −10° C. to about 20° C., 20° C. to about 50° C., about 50° C. to about 70° C., about 70° C. to about 85° C., about 30° C. to about 95° C., or from about 85° C. to about 100° C.

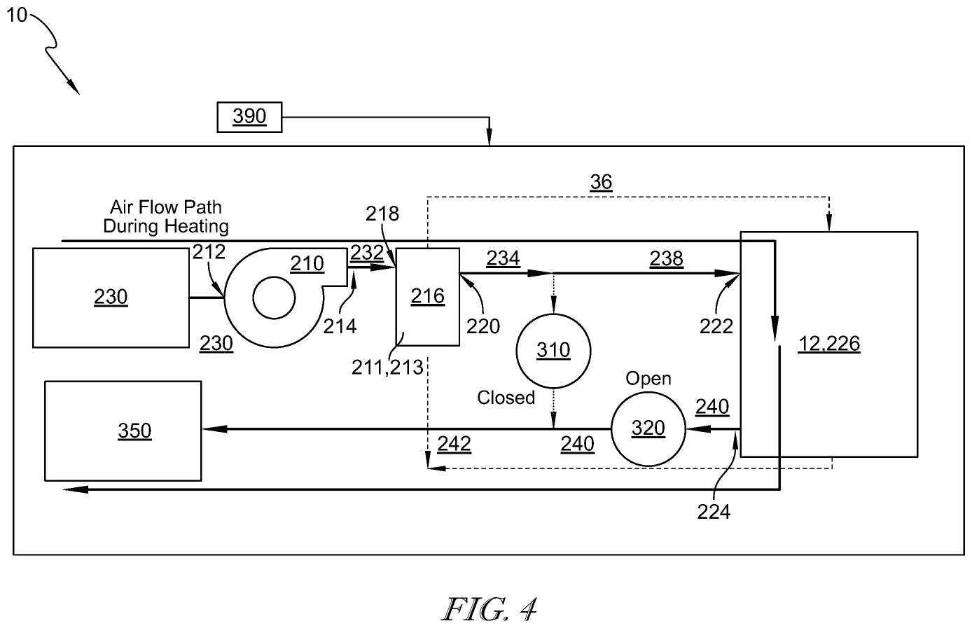

As shown in FIGS. 3 and 4, the fuel cell system 10 can include a control system 390, and one or more valves (e.g., a by-pass valve 310 and/or a backpressure valve 320), which may be regulated, controlled, and/or implemented by the control system 390 to direct the flow of air in the fuel cell system 10. The control system 390 may control, regulate, implement, and/or operate one or more components in the fuel cell system 10. The control system 390 may control, regulate, implement, and/or respond to an operating state of the fuel cell stack (e.g., startup, steady state operation, transient operation, and/or shutdown).

In one embodiment, as shown in FIG. 3, the control system 390 can regulate, measure, and/or operate the by-pass valve 310 and/or the backpressure valve 320 so that the by-pass valve 310 is open and the backpressure valve 320 is closed. As previously described, the filtered air stream 230 can enter the compressor 210 at the compressor inlet 212 and exit the compressor 210 at the compressor outlet 214 as the compressor outlet stream 232. The compressor outlet stream 232 can enter the charge cooler 216 at a charge cooler inlet 218 and exit the charge cooler 216 at a charge cooler outlet 220 as the charge cooler outlet stream 234. The charge cooler outlet stream 234 can enter the fuel cell stack 12.

The charge cooler outlet stream 234 can flow as a by-pass air stream 236 through the by-pass valve 310 into an exhaust 350, thereby bypassing the fuel cell stack 12. In some embodiments, the control system 390 can initiate or implement an operation of the fuel cell system 10 where the compressor outlet stream 232 by-passes the fuel cell stack 12 and heats the coolant 36 flowing through the charge cooler 216. Such an embodiment would be beneficial under cold operating conditions, including cold start-up conditions.

Typically, if air is flowing through the charge cooler 216 as the compressor outlet stream 232, then the coolant 36 will be configured to absorb heat from the compressor outlet stream 232. Under normal operation of the fuel cell system 10, the coolant 36 flow is designed to absorb heat from the compressor outlet stream 232. The temperature of the coolant 36 circulating through the charge cooler 216 can range from about −40° C. to about 100° C., including any temperature or range of temperatures comprised therein. For example, the temperature of the coolant 36 can range from about −40° C. to about −10° C., about −10° C. to about 20° C., 20° C. to about 50° C., about 50° C. to about 70° C., about 70° C. to about 85° C., or from about 85° C. to about 100° C. In one embodiment, the temperature of the coolant 36 as it exits the charge cooler 216 may range from about 30° C. to about 95° C., including any temperature or range of temperatures comprised therein.

The distinction between cold start-up and regular operation of the fuel cell system 10 or fuel cell stack 12 is that the fuel cell stack 12 cannot be started or initiated if the surrounding environmental temperatures (e.g., ambient temperatures) are below the fuel cell stack 12 starting temperature of about 0° C. to about 3° C., including any temperature or range of temperatures comprised therein, such as about 3 ºC. Thus, during a cold start-up of the system 10, all air passes through the by-pass valve 310 instead of the fuel cell stack 12 to prevent damage to the fuel cell stack 12 until the coolant 36 is warm enough to initiate operation of the stack 12.

In one embodiment, as shown in FIG. 4, the control system 390 can regulate, measure, and/or operate the by-pass valve 310 and the backpressure valve 320, so that the backpressure valve 320 is open and the by-pass valve 310 is closed. The compressor outlet stream 232 can flow through the charge cooler 216 and exit the charger cooler 216 as the charge cooler outlet stream 234. The charge cooler outlet stream 234 can flow as a stack air stream 238 by bypassing the by-pass valve 310 into the fuel cell stack 12. The stack air stream 238 can exit the fuel cell stack 12 through the backpressure valve 320 into the exhaust 350. Such a configuration or operation enables the fuel cell stack 12 to be directly heated by allowing at least a portion of heat energy comprised in the compressor outlet stream 232 flowing into the fuel cell stack inlet 222 as the stack air stream 238.

The stack air stream 238 passing through the fuel cell stack 12 can directly heat one or more cathode channels 226 in the fuel cell stack 12 before exiting the fuel cell stack 12 at a cathode outlet 224. The stack air stream 238 can be used to melt frozen water in the cathode channels 226 in the fuel cell stack 12 prior to operating the fuel cell stack 12. The stack air stream 238 can be used to melt frozen water in other parts of the fuel cell stack 12, such as prior to operating the fuel cell stack 12.

In some embodiments, the temperature of the stack air stream 238 may be the same as the temperature of the charge cooler outlet stream 234. In other embodiments, the temperature of the stack air stream 238 may be different from the temperature of charge cooler outlet stream 234. The temperature of the stack air stream 238 can range from about −40° C. to about 100° C., including any specific or range of temperatures comprised therein. For example, the temperature of the stack air stream 238 can range from about −40° C. to about −10° C., about −10° C. to about 20° C., 20° C. to about 50° C., about 50° C. to about 70° C., about 70° C. to about 85° C., about 30° C. to about 95° C., or from about 85° C. to about 100° C.

The control system 390 may monitor, regulate, and/or measure fuel cell system 10 or stack 12 parameters, including but not limited to fuel cell stack pressures, temperatures, flowrates, voltage, current, etc., as well as ambient humidity, compressor speed, and/or balance of plant (BOP) parameters. In some embodiments, the control system 390 may monitor, regulate, and/or measure fuel cell system 10 or stack 12 parameters in due course (e.g., when it makes logistical, systemic, and/or economic sense to do so). In some embodiments, the control system 390 may monitor, regulate, and/or measure fuel cell system 10 or stack 12 parameters in real-time.

The phrase ‘in real-time’ refers to at least one of the times of occurrence of the associated events, e.g., the time of measurement and collection of parameters, the time to process the parameters, and/or the time of a system response to the parameters occur instantaneously or substantially instantaneously. Systems, components, and/or methods operating or functioning in real-time are doing so instantaneously or substantially instantaneously (e.g., in the present or current time). For example, fuel cell system 10 components (e.g., stack 12 or others) parameters can be accessed and/or assessed in real-time (e.g., instantaneously or substantially instantaneously) by the control system 390.

Additionally, the control system 390 may then control, monitor, and/or regulate the operation of the different components of the fuel cell system 10 in real-time and/or in due course. For example, the control system 390 may adjust, regulate, close, and/or open the by-pass valve 310 and/or the backpressure valve 320 as necessary during system 10 or stack 12 operation. The operation of the control system 390 may be based on the temperature of the coolant 36, ambient/environmental temperature and/or the operating state of the fuel cell stack.

In some exemplary embodiments, only one of the by-pass valve 310 and the backpressure valve 320 may be open. For example, in one embodiment, the by-pass valve 310 may be open and the backpressure valve 320 may be closed. In another embodiment, the by-pass valve 310 may be closed and the backpressure valve 320 may be open. In other embodiments, both the by-pass valve 310 and the backpressure valve 320 may be open.

In other embodiments, both the by-pass valve 310 and the backpressure valve 320 will not be open (e.g., closed). For example, if both the by-pass valve 310 and the backpressure valve 320 are closed, the fuel cell system 10 may be configured with a different component to exhaust the charge cooler outlet stream 234. Additionally, both valves 310, 320 may be closed when the fuel cell system 10 is undergoing shutdown.

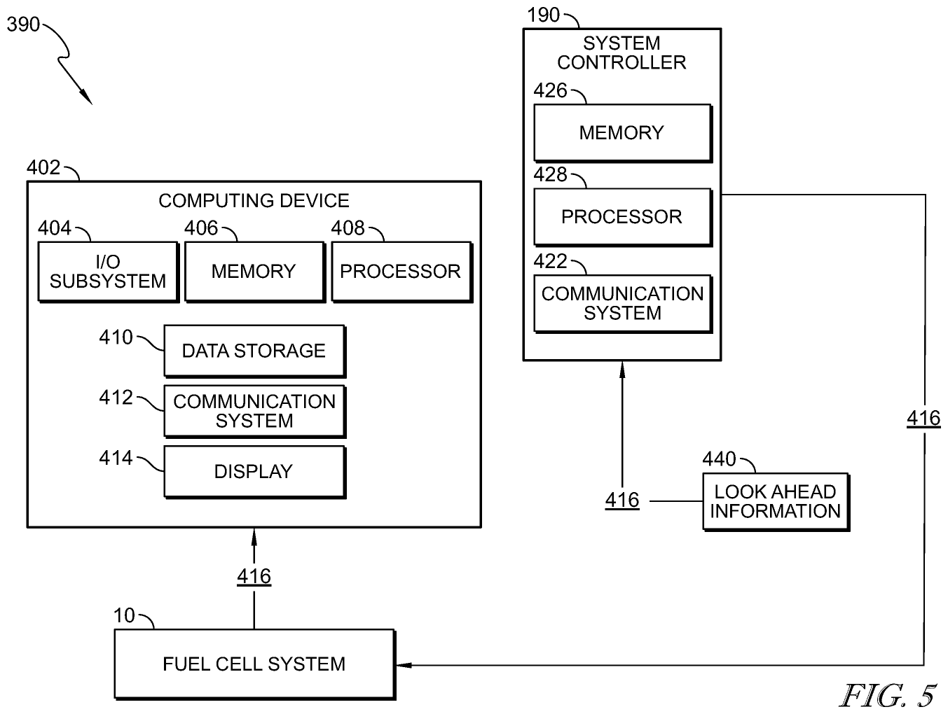

FIG. 5 illustrates one embodiment of the control system 390. The control system 390 may initiate, implement, regulate, measure, monitor, and/or control operation of one or more components of the fuel cell system 10. The control system 390 includes a system controller 190. In some embodiments, to facilitate the transfer of data and other network communications across the fuel cell system 10, the system controller 190 may be in communication with a computing device 402 over a network 416. The computing device 402 may be in communication with one or more components of the fuel cell system 10. In some embodiments, the system controller 190 may include a memory 426, a processor 428, and/or a communication subsystem 422.

The computing device 402 may be embodied as any type of computation or computer device capable of performing the functions described herein, including, but not limited to, a server (e.g., stand-alone, rack-mounted, blade, etc.), a network appliance (e.g., physical or virtual), a high-performance computing device, a web appliance, a distributed computing system, a computer, a processor-based system, a multiprocessor system, a smartphone, a tablet computer, a laptop computer, a notebook computer, and a mobile computing device.

The illustrative computing device 402 of FIG. 5 may include one or more of an input/output (I/O) subsystem 404, a memory 406, a processor 408, a data storage device 410, a communication subsystem 412, and a display 414 that may be connected to each other, in communication with each other, and/or configured to be connected and/or in communication with each other through wired, wireless and/or power line connections and associated protocols (e.g., Ethernet, InfiniBand®, Bluetooth®, Wi-Fi®, WiMAX, 3G, 4G LTE, 5G, etc.).

The computing device 402 may also include additional and/or alternative components, such as those commonly found in a computer (e.g., various input/output devices). In other embodiments, one or more of the illustrative computing device 402 of components may be incorporated in, or otherwise form a portion of, another component. For example, the memory 406, or portions thereof, may be incorporated in the processor 408.

The processors 408, 428 may be embodied as any type of computational processing tool or equipment capable of performing the functions described herein. For example, the processor 408, 428 may be embodied as a single or multi-core processor(s), digital signal processor, microcontroller, or other processor or processing/controlling circuit. The memory 406, 426 may be embodied as any type of volatile or non-volatile memory or data storage capable of performing the functions described herein.

In operation, the memory 406, 426 may store various data and software used during operation of the computing device 402 and/or system controller 190 such as operating systems, applications, programs, libraries, and drivers. The memory 406 is communicatively coupled to the processor 408 via the I/O subsystem 404, which may be embodied as circuitry and/or components to facilitate input/output operations with the processor 408, the memory 406, and other components of the computing device 402.

For example, the I/O subsystem 404 may be embodied as, or otherwise include, memory controller hubs, input/output control hubs, sensor hubs, host controllers, firmware devices, communication links (i.e., point-to-point links, bus links, wires, cables, light guides, printed circuit board traces, etc.) and/or other components and subsystems to facilitate the input/output operations.

In one embodiment, the memory 406 may be directly coupled to the processor 808, for example via an integrated memory controller hub. Additionally, in some embodiments, the I/O subsystem 404 may form a portion of a system-on-a-chip and be incorporated, along with the processor 408, the memory 406, and/or other components of the computing device 402, on a single integrated circuit chip (not shown).

The memory 426 is communicatively coupled to the processor 428, which may be embodied as circuitry and/or components to facilitate input/output operations with the processor 428, the memory 426, and other components of the system controller 190. In one embodiment, the memory 426 may be directly coupled to the processor 428. In some components, the processor 428 may perform the functions of the processor 408. In other embodiments, the system controller may comprise the computing device 402.

The data storage device 410 may be embodied as any type of device or devices configured for short-term or long-term storage of data such as, for example, memory devices and circuits, memory cards, hard disk drives, solid-state drives, or other data storage devices. The computing device 402 also includes the communication subsystem 412, which may be embodied as any communication circuit, device, or collection thereof, capable of enabling communications between the computing device 402 and other remote devices over the computer network 416.

The components of the communication subsystem 412 may be configured to use any one or more communication technologies (e.g., wired, wireless and/or power line communications) and associated protocols (e.g., Ethernet, InfiniBand®, Bluetooth®, Wi-Fi®, WiMAX, 3G, 4G LTE, 5G, etc.) to effect such communication among and between system components and devices.

The system controller 190 may be connected and/or in communication with the computing device 402, the fuel cell system 10, and additional features or components (not shown) of the vehicle 100 comprising fuel cell system 10. The above mentioned components may be connected, communicate with each other, and/or configured to be connected or in communication with each over the network 816 using one or more communication technologies (e.g., wired, wireless and/or power line communications) and associated protocols (e.g., Ethernet, InfiniBand®, Bluetooth®, Wi-Fi®, WiMAX, 3G, 4G LTE, 5G, etc.

The display 414 of the computing device 402 may be embodied as any type of display capable of displaying digital and/or electronic information, such as a liquid crystal display (LCD), a light emitting diode (LED), a plasma display, a cathode ray tube (CRT), or other type of display device. In some embodiments, the display 414 may be coupled to or otherwise include a touch screen or other input device.

The computing device 402 may also include any number of additional input/output devices, interface devices, hardware accelerators, and/or other peripheral devices. The computing device 402 may be configured into separate subsystems for managing data and coordinating communications throughout the fuel cell system 10. In some embodiments, the computing system 402 may be a part of the system controller 190.

One embodiment of the current disclosure is directed towards a method of operating the fuel cell systems 10 described in FIGS. 3-5 under cold operating conditions. Cold operating conditions often include temperatures that are the same or similar temperatures as previously specified for a cold start-up temperature (e.g., below 0° C. to about 3° C.). However, cold operating conditions may also include environmental conditions where the weather and/or weather conditions include raining, snowing, sleeting, hailing, drizzling, and/or freezing conditions.

The method of operating the fuel cell system 10 under cold operating conditions may include the control system 390 implementing, using, and/or utilizing the compressor outlet stream 232 to heat the coolant 36 flowing through the charge cooler 216. The method may include the control system 390 implementing, using, and/or utilizing heat and/or heat energy from the compressor outlet stream 232 to heat cathode channels 226 in the fuel cell stack 12.

The method of implementing, using, and/or utilizing the present fuel cell system 10 may include operating the compressor 210 at a high pressure ratio and/or at a mass flow to increase the heat energy in the compressor outlet stream 232. The ratio of pressure at the compressor inlet 212 to the pressure at the compressor outlet 214 (e.g., CI_{P}:CO_{P}) may range from about 1 to about 3.5, including any pressure ratio or range comprised therein. The pressure ratio may also be based on the operating state of the fuel cell system 10. For example, the pressure ratio may depend on if the fuel cell system 10 is operating under steady state conditions or under transient conditions.

The method of operating the fuel cell system 10 under cold operating conditions may further include the control system 390 regulating, operating, and/or adjusting the by-pass valve 310 and/or the backpressure valve 320 based on the operating conditions of the fuel cell system 10 or components comprised in the fuel cell system 10. For example, in one embodiment, the method of operating the fuel cell system 10 under cold operating conditions may include the control system 390 calculating and/or measuring the temperature of the surrounding environment of the fuel cell system 10. The method may further include the control system 390 operating and/or controlling different components of the fuel cell system 10 including the fuel cell stack 12, the by-pass valve 310, and the backpressure valve 320 based on the measured and/or calculated ambient temperature.

As shown in FIGS. 4-5, the method of operating the fuel cell system 10 may further include the control system 390 determining, measuring, monitoring, and/or detecting whether the coolant 36 flowing through the charge cooler 216 requires heating. In some embodiments, the coolant 36 flowing through the charge cooler 216 may require heating if the temperature of the coolant 36 is below the minimum operating temperature of about −5° C. to about 5° C., including any temperature or range of temperatures comprised therein. In some embodiments, the coolant 36 flowing through the charge cooler 216 may require heating until the coolant 36 is heated to a temperature of about 30° C. to about 100° C., including any temperature or range of temperature comprised therein. For example, the coolant 36 flowing through the charge cooler 216 may be heated to a temperature of about 30° C. to about 40° C., of about 40° C. to about 50° C., of about 50° C. to about 60° C., of about 60° C. to about 70° C., of about 70° C. to about 80° C., or of about 80° C. to about 100° C.

The method may further include the control system 390 opening the by-pass valve 310 and closing the backpressure valve 320 if the coolant 36 is required to be heated. For example, the method may include the control system 390 opening the by-pass valve 310 and closing the backpressure valve 320 for a first duration to heat the coolant 36. The first duration may include a first time period ranging from about 10 seconds to about 150 seconds including any specific or range of time comprised therein. For example, the first duration may include a first time period ranging from about 10 seconds to about 50 seconds, about 50 seconds to about 100 seconds, or about 100 seconds to about 150 seconds including any specific or range of time comprised therein. In some embodiments, the first duration may be less than about 10 seconds or more than about 150 seconds. The first duration may also be pre-determined or may be based on continuous measurements by the control system 390 of the coolant 36 temperature and/or ambient temperature. Alternatively or additionally, the first duration may be based on look-up tables, computational models, experimental models, and/or other variables, parameters, and/or information.

The method of operating the fuel cell system 10 under cold operating conditions may also include the control system 390 determining measuring, monitoring, or detecting if one or more components (e.g., the cathode channels 226) of the fuel cell stack 12 require heating. The method may include the control system 390 closing the by-pass valve 310 and opening the backpressure valve 320 if one or more components of the fuel cell stack 12 (e.g., cathode channels 226) is determined or detected to require heating.

The method of operating the fuel cell system 10 may further include the control system 390 closing the by-pass valve 310 and opening the backpressure valve 320 for a second duration. The second duration may include a second time period ranging from about 10 seconds to about 150 seconds including any specific or range of time comprised therein. For example, the second duration may include a second time period ranging from about 10 seconds to about 50 seconds, about 50 seconds to about 100 seconds, or about 100 seconds to about 150 seconds including any specific or range of time comprised therein. In some embodiments, the second duration may be less than about 10 seconds or more than about 150 seconds. The second duration may also be pre-determined or may be based on continuous measurements by the control system 390 of the coolant 36 temperature and/or ambient temperature. Alternatively or additionally, the second duration may be based on look-up tables, computational models, experimental models, and/or other variables, parameters, and/or information.

A first aspect of the present invention relates to a fuel cell system, comprising a coolant stream flowing through a fuel cell stack, a compressor including a compressor inlet and a compressor outlet, configured to flow a first air stream comprising a first air temperature into the compressor inlet and a second air stream comprising a second air temperature out of the compressor outlet. A charge cooler including a charge cooler inlet and a charge cooler outlet are configured to flow the second air stream comprising the second air temperature into the charge cooler inlet and a third air stream comprising a third air temperature out of the charge cooler outlet. The second air temperature is higher than the first air temperature and the third air temperature is lower than the second air temperature. A controller is configured to regulate operation of the fuel cell stack, the compressor, and the charge cooler.

A second aspect of the present invention relates to a method of operating a fuel cell system comprising implementing a control system to operate the fuel cell system, flowing a first air stream through a compressor at a first air temperature, flowing a second air stream out of the compressor and into a charge cooler at a second air temperature higher than the first air temperature, flowing a third air stream out of the charge cooler at a third air temperature lower than the second air temperature, and. flowing a coolant stream through the charger cooler and a fuel cell stack, wherein heat energy from the second air stream is configured to increase a first coolant temperature of the coolant stream to a second coolant temperature.

In the first aspect of the present invention, the heat energy from the second air stream may be configured to increase a first coolant temperature of the coolant stream to a second coolant temperature when the coolant stream flows through the charge cooler.

In the first aspect of the present invention, the coolant stream comprising the second coolant temperature may be configured to flow through the fuel cell stack after flowing through the charge cooler and the fuel cell stack is heated by the coolant stream comprising the second temperature.

In the first aspect of the present invention, the system may further comprise a by-pass valve configured to flow a first portion of the third air stream into an exhaust. In the first aspect of the present invention, the coolant stream comprising the second coolant temperature may be configured to flow through the fuel cell stack after flowing through the charge cooler and the fuel cell stack is heated by the coolant stream comprising the second temperature.

In the first aspect of the present invention, the system may further comprise the third air stream flowing through the fuel cell stack and a backpressure valve configured to flow the third air stream into an exhaust after the third air stream exits the fuel cell stack. In the first aspect of the present invention, the coolant stream comprising the second coolant temperature may be configured to flow through the fuel cell stack and heat the fuel cell stack. In the first aspect of the present invention, the third air stream flowing through the fuel cell stack may be configured to melt frozen water in a cathode channel in the fuel cell stack.

In the first aspect of the present invention, the system may further comprise a backpressure valve and a by-pass valve, wherein the controller is configured to operate the backpressure valve or the by-pass valve based on coolant temperature, ambient temperature, or an operating state of the fuel cell stack. In the first aspect of the present invention, the second air temperature may depend on a ratio of a pressure of the first air stream to a pressure of the second air stream. In the first aspect of the present invention, the second air temperature may range from about 40° C. to about 230° C. In the first aspect of the present invention, the third air temperature may range from about 40° C. to about 100° C. In the first aspect of the present invention, the second coolant temperature may range from about 40° C. to about 100° C.

In the second aspect of the present invention, the method may further comprise flowing a first portion of the third air stream into an exhaust via a by-pass valve. In the second aspect of the present invention, the method may further comprise flowing a first portion of the third air stream into the fuel cell stack before flowing the second portion of the third air stream into an exhaust, wherein flowing the second portion of the third air stream into the exhaust comprises the control system operating a backpressure valve. In the second aspect of the present invention, the method may further comprise flowing the coolant stream comprising the second coolant temperature through the fuel cell stack and heating the fuel cell stack.

In the second aspect of the present invention, the method may further comprise the controller: a) operating a by-pass valve for flowing a first portion of the third air stream to an exhaust or b) flowing a second portion of the third air stream through the fuel cell stack and to a backpressure valve before the exhaust. In the second aspect of the present invention, the method may further comprise the control system operating the backpressure valve or the by-pass valve based on a coolant temperature, an ambient temperature, or an operating state of the fuel cell stack. In the second aspect of the present invention, the method may further comprise the controller opening the by-pass valve and closing the backpressure valve for a first duration and closing the by-pass valve and opening the backpressure valve for a second duration.

The features illustrated or described in connection with one exemplary embodiment or aspect may be combined with any other feature or element of any other embodiment or aspect described herein. Such modifications and variations are intended to be included within the scope of the present disclosure. Further, a person skilled in the art will recognize that terms commonly known to those skilled in the art may be used interchangeably herein.

The above embodiments and aspects are described in sufficient detail to enable those skilled in the art to practice what is claimed and it is to be understood that other embodiments may be utilized and that logical, mechanical, and electrical changes may be made without departing from the spirit and scope of the claims. The detailed description is, therefore, not to be taken in a limiting sense.

As used herein, an element or step recited in the singular and proceeded with the word “a” or “an” should be understood as not excluding plural of said elements or steps, unless such exclusion is explicitly stated.

Furthermore, references to “one embodiment” of the presently described subject matter are not intended to be interpreted as excluding the existence of additional embodiments that also incorporate the recited features. Specified numerical ranges of units, measurements, and/or values include, consist essentially or, or consist of all the numerical values, units, measurements, and/or ranges including or within those ranges and/or endpoints, whether those numerical values, units, measurements, and/or ranges are explicitly specified in the present disclosure or not.

Unless defined otherwise, technical and scientific terms used herein have the same meaning as is commonly understood by one of ordinary skill in the art to which this disclosure belongs. The terms “first,” “second,” “third,” and the like, as used herein do not denote any order or importance, but rather are used to distinguish one element from another. The term “or” and “and/or” is meant to be inclusive and mean either or all of the listed items. In addition, the terms “connected” and “coupled” are not restricted to physical or mechanical connections or couplings, and can include electrical connections or couplings, whether direct or indirect.

Moreover, unless explicitly stated to the contrary, embodiments “comprising,” “including,” or “having” an element or a plurality of elements having a particular property may include additional such elements not having that property. The term “comprising” or “comprises” refers to a composition, compound, formulation, or method that is inclusive and does not exclude additional elements, components, and/or method steps. The term “comprising” also refers to a composition, compound, formulation, or method embodiment of the present disclosure that is inclusive and does not exclude additional elements, components, or method steps. The phrase “consisting of” or “consists of” refers to a compound, composition, formulation, or method that excludes the presence of any additional elements, components, or method steps.

The term “consisting of” also refers to a compound, composition, formulation, or method of the present disclosure that excludes the presence of any additional elements, components, or method steps. The phrase “consisting essentially of” or “consists essentially of” refers to a composition, compound, formulation, or method that is inclusive of additional elements, components, or method steps that do not materially affect the characteristic(s) of the composition, compound, formulation, or method. The phrase “consisting essentially of” also refers to a composition, compound, formulation, or method of the present disclosure that is inclusive of additional elements, components, or method steps that do not materially affect the characteristic(s) of the composition, compound, formulation, or method steps.

Approximating language, as used herein throughout the specification and claims, may be applied to modify any quantitative representation that could permissibly vary without resulting in a change in the basic function to which it is related. Accordingly, a value modified by a term or terms, such as “about,” and “substantially” is not to be limited to the precise value specified. In some instances, the approximating language may correspond to the precision of an instrument for measuring the value. Here and throughout the specification and claims, range limitations may be combined and/or interchanged. Such ranges are identified and include all the sub-ranges contained therein unless context or language indicates otherwise.

As used herein, the terms “may” and “may be” indicate a possibility of an occurrence within a set of circumstances; a possession of a specified property, characteristic or function; and/or qualify another verb by expressing one or more of an ability, capability, or possibility associated with the qualified verb. Accordingly, usage of “may” and “may be” indicates that a modified term is apparently appropriate, capable, or suitable for an indicated capacity, function, or usage, while taking into account that in some circumstances, the modified term may sometimes not be appropriate, capable, or suitable.

It is to be understood that the above description is intended to be illustrative, and not restrictive. For example, the above-described embodiments (and/or aspects thereof) may be used individually, together, or in combination with each other. In addition, many modifications may be made to adapt a particular situation or material to the teachings of the subject matter set forth herein without departing from its scope. While the dimensions and types of materials described herein are intended to define the parameters of the disclosed subject matter, they are by no means limiting and are exemplary embodiments. Many other embodiments will be apparent to those of skill in the art upon reviewing the above description. The scope of the subject matter described herein should, therefore, be determined with reference to the appended claims, along with the full scope of equivalents to which such claims are entitled.

This written description uses examples to disclose several embodiments of the subject matter set forth herein, including the best mode, and also to enable a person of ordinary skill in the art to practice the embodiments of disclosed subject matter, including making and using the devices or systems and performing the methods. The patentable scope of the subject matter described herein is defined by the claims, and may include other examples that occur to those of ordinary skill in the art. Such other examples are intended to be within the scope of the claims if they have structural elements that do not differ from the literal language of the claims, or if they include equivalent structural elements with insubstantial differences from the literal languages of the claims.

While only certain features of the invention have been illustrated and described herein, many modifications and changes will occur to those skilled in the art. It is, therefore, to be understood that the appended claims are intended to cover all such modifications and changes as fall within the true spirit of the invention.

What is claimed is:

1. A fuel cell system, comprising:
a coolant stream flowing through a fuel cell stack,
a compressor including a compressor inlet and a compressor outlet, configured to flow a first air stream comprising a first air temperature into the compressor inlet and a second air stream comprising a second air temperature out of the compressor outlet, wherein the second air temperature is higher than the first air temperature,
a charge cooler including a charge cooler inlet and a charge cooler outlet, configured to flow the second air stream comprising the second air temperature into the charge cooler inlet and a third air stream comprising a third air temperature out of the charge cooler outlet, wherein the third air temperature is lower than the second air temperature, and
a controller configured to regulate operation of the fuel cell stack, the compressor, and the charge cooler.

2. The system of claim 1, wherein heat energy from the second air stream is configured to increase a first coolant temperature of the coolant stream to a second coolant temperature when the coolant stream flows through the charge cooler.

3. The system of claim 2, wherein the coolant stream comprising the second coolant temperature is configured to flow through the fuel cell stack after flowing through the charge cooler and wherein the fuel cell stack is heated by the coolant stream comprising the second temperature.

4. The system of claim 2, further comprising a by-pass valve configured to flow a first portion of the third air stream into an exhaust.

5. The system of claim 4, wherein the coolant stream comprising the second coolant temperature is configured to flow through the fuel cell stack after flowing through the charge cooler and wherein the fuel cell stack is heated by the coolant stream comprising the second temperature.

6. The system of claim 2, further comprising the third air stream flowing through the fuel cell stack and a backpressure valve configured to flow the third air stream into an exhaust after the third air stream exits the fuel cell stack.

7. The system of claim 6, wherein the coolant stream comprising the second coolant temperature is configured to flow through the fuel cell stack and heat the fuel cell stack.

8. The system of claim 6, wherein the third air stream flowing through the fuel cell stack is configured to melt frozen water in a cathode channel in the fuel cell stack.

9. The system of claim 1, further comprising a backpressure valve and a by-pass valve, wherein the controller is configured to operate the backpressure valve or the by-pass valve based on coolant temperature, ambient temperature, or an operating state of the fuel cell stack.

10. The system of claim 1, wherein the second air temperature depends on a ratio of a pressure of the first air stream to a pressure of the second air stream.

11. The system of claim 1, wherein the second air temperature ranges from about 40° C. to about 230° C.

12. The system of claim 1, wherein the third air temperature ranges from about 40° C. to about 100° C.

13. The system of claim 2, wherein the second coolant temperature ranges from about 40° C. to about 100° C.

14. A method of operating a fuel cell system comprising:
implementing a control system to operate the fuel cell system,
flowing a first air stream through a compressor at a first air temperature,
flowing a second air stream out of the compressor and into a charge cooler at a second air temperature higher than the first air temperature,
flowing a third air stream out of the charge cooler at a third air temperature lower than the second air temperature, and
flowing a coolant stream through the charger cooler and a fuel cell stack, wherein heat energy from the second air stream is configured to increase a first coolant temperature of the coolant stream to a second coolant temperature.

15. The method of claim 14, further comprising flowing a first portion of the third air stream into an exhaust via a by-pass valve.

16. The method of claim 14, further comprising flowing a first portion of the third air stream into the fuel cell stack before flowing the second portion of the third air stream into an exhaust, wherein flowing the second portion of the third air stream into the exhaust comprises the control system operating a backpressure valve.

17. The method of claim 14, further comprising flowing the coolant stream comprising the second coolant temperature through the fuel cell stack and heating the fuel cell stack.

18. The method of claim 14, further comprising the controller: a) operating a by-pass valve for flowing a first portion of the third air stream to an exhaust or b) flowing a second portion of the third air stream through the fuel cell stack and to a backpressure valve before the exhaust.

19. The method of claim 18, further comprising the control system operating the backpressure valve or the by-pass valve based on a coolant temperature, an ambient temperature, or an operating state of the fuel cell stack.

20. The method of claim 18, further comprising the controller opening the by-pass valve and closing the backpressure valve for a first duration and closing the by-pass valve and opening the backpressure valve for a second duration.
